(19) United States
(12) Patent Application Publication
(10) Pub. No.: US 2009/0322732 A1
(43) Pub. Date: Dec. 31, 2009

(54) METHOD FOR DRIVING PLASMA DISPLAY PANEL AND PLASMA DISPLAY DEVICE

(75) Inventors: Kenji Ogawa, Osaka (JP); Shinichiro Hashimoto, Osaka (JP); Shunsuke Kawai, Osaka (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/279,108

(22) PCT Filed: Dec. 4, 2007
(86) PCT No.: PCT/JP2007/073376

§ 371 Date: Aug. 12, 2008

(30) Foreign Application Priority Data
Jan. 15, 2007 (JP) 2007-005612

(51) Int. Cl. G09G 5/00; G09G 3/28

(52) U.S. Cl. 345/214; 345/60

(57) ABSTRACT

The method for driving a plasma display panel effects control of the subfields as follows. The all-cell initializing operation on the discharge cell is carried out in the initializing period of at least one sub-filed; the rest of the subfields other than the aforementioned subfield selectively carry out an addressing operation in each discharge cell. Gradation display is attained by combination of a subfield having an address discharge in the address period and a sub-filed with no address discharge in the address period. In a discharge cell where an address discharge is generated in the address period of a subfield that follows the subfield having the all-cell initializing operation in the initializing period, the subfield having the all-cell initializing operation has an address period for generating an address discharge.

### TECHNICAL FIELD

The present invention relates to a method for driving a plasma display panel used for wall-hanging TVs or large monitors and also relates to a plasma display device.

### BACKGROUND ART

An AC-type surface discharge plasma display panel has become dominance in plasma display panels (hereinafter simply referred to as a panel). The panel contains a front plate and a rear plate oppositely disposed with each other and a plurality of discharge cells therebetween. On the front plate, display electrodes; each of which is formed of a pair of a scan electrode and a sustain electrode, are arranged in parallel with each other. On the rear plate, data electrodes are disposed in a parallel arrangement. In the panel structured above, a gas discharge occurs in each discharge cell and generates ultraviolet light, which excites phosphors for red (R), green (G) and blue (B) to generate visible light of respective colors.

In the typical panel operation, one field is divided into a plurality of subfields, which is known as a subfield method. According to the subfield method, gradation display on the panel is attained by combination of the subfields to be lit. Each subfield has an initializing period, an address period and a sustain period.

In the initializing period, an initializing discharge occurs in the discharge cells. The initializing discharge generates wall charge on each electrode as a preparation for an addressing operation in the address period that follows the initializing period. There are two types of initializing operation carried out in the initializing period: selective-cell initializing operation and all-cell initializing operation. In the selective-cell initializing operation, an initializing discharge occurs only in a discharge cell that had a sustain discharge in the sustain period of the previous subfield. In the all-cell initializing operation, the initializing discharge occurs in all of the discharge cells.

In the address period, an address discharge selectively occurs in a cell to be ON to form the wall charge. In the sustain period successive to the address period, sustain pulses are alternately applied between the scan electrodes and the sustain electrodes. The application of pulses generates a sustain discharge in the cells in which the wall charges have been formed in the previous address discharge and excites the phosphor layer of the cells. Through the process above, image is shown on the panel.

In the subfield methods, an improved driving method is disclosed. According to the disclosure, an effective use of the all-cell initializing operation by the application of voltage with a gradually varying waveform and the selective-cell initializing operation can suppress light-emitting that has no contribution to gradation display and therefore improves contrast ratio (see patent reference 1, for example).

As a recent trend, panels are becoming larger with higher resolution; on the other hand, the discharge cells are becoming finer. Forming discharge cells finer makes difficult to control wall charges in the cells. An improper control on wall charges invites poor address operation for example, no address discharge in a cell where it should be generated, degrading quality of image on the panel.

Patent reference 1: Japanese Unexamined Patent Application Publication No. 2000-242224

### SUMMARY OF THE INVENTION

The present invention discloses a method for driving a plasma display panel having a plurality of discharge cells, each of the discharge cells including a display electrode pair, which is formed of a scan electrode and a sustain electrode, and a data electrode. One field is formed of a plurality of subfields each of which has the following periods: an initializing period for generating an initializing discharge in the discharge cells; an address period for selectively generating an address discharge in the discharge cells; and a sustain period for generating a sustain discharge in a discharge cell where an address discharge occurred in the previous address period. The driving method effects control of the subfields as follows. The all-cell initializing operation on the discharge cell is carried out in the initializing period of at least one sub-filed; the rest of the subfields other than the aforementioned subfield selectively carry out an addressing operation in each discharge cell. Gradation display is attained by combination of a subfield having an address discharge in the address period and a sub-filed with no address discharge in the address period.

In a discharge cell where an address discharge is generated in the address period in a subfield that follows the subfield having the all-cell initializing operation in the initializing period, the subfield having the all-cell initializing operation has an address period for generating an address discharge. Such structured driving method eliminates a poor panel operation, even in a panel with high resolution, providing excellent image display.

According to the driving method of the present invention, after an application of sustain pulses to the display electrodes, a mildly increasing voltage with a ramp waveform is applied to the scan electrodes in the sustain period.

The plasma display device of the present invention has a panel having a plurality of discharge cells formed of display electrodes, each of which is formed of a pair of a scan electrode and a sustain electrode, and data electrodes, and a driving circuit for driving the panel. In the subfield method, as described above, one field is divided into a plurality of subfields each of which has the following periods: an initializing period for generating an initializing discharge in the discharge cells; an address period for selectively generating an address discharge in the discharge cells; and a sustain period for generating a sustain discharge in a discharge cell where an address discharge occurred in the previous address period. The driving circuit effects control of the subfields in the following manner. The all-cell initializing operation on the discharge cell is carried out in the initializing period of at least one sub-filed. In a discharge cell where an address discharge is generated in the address period in a subfield that follows the subfield having the all-cell initializing operation, the preceding subfield, where the all-cell initializing operation occurred in the initializing period, has also the address period for generating an address discharge.

With the structure above, the present invention provides a method for driving plasma display panel and a plasma display device without malfunction, even in a high-resolution panel, offering the device to display image of high quality.

### BRIEF DESCRIPTION OF THE DRAWINGS

FIG. 1 is an exploded perspective view showing the structure of a panel in accordance with an exemplary embodiment of the present invention.

FIG. 2 shows arrangement of electrodes on the panel in accordance with the exemplary embodiment.

FIG. 3 is a circuit block diagram of the plasma display device of the embodiment.

FIG. 4 shows waveforms of driving voltage to be applied to each electrode of the embodiment.

FIG. 5 shows a coding example in the embodiment.

FIG. 6 shows another coding example in an exemplary embodiment.

FIG. 7 shows still another coding example in an exemplary embodiment.

### REFERENCE MARKS IN THE DRAWINGS

10 panel
22 scan electrode
23 sustain electrode
24 display electrode
32 data electrode
51 image-signal processing circuit
52 data-electrode driving circuit
53 scan-electrode driving circuit
54 sustain-electrode driving circuit
55 timing-signal generating circuit
100 plasma display device

### DETAILED DESCRIPTION OF THE PREFERRED EMBODIMENTS

The plasma display device of an exemplary embodiment of the present invention is described hereinafter with reference to the accompanying drawings.

### Exemplary Embodiment

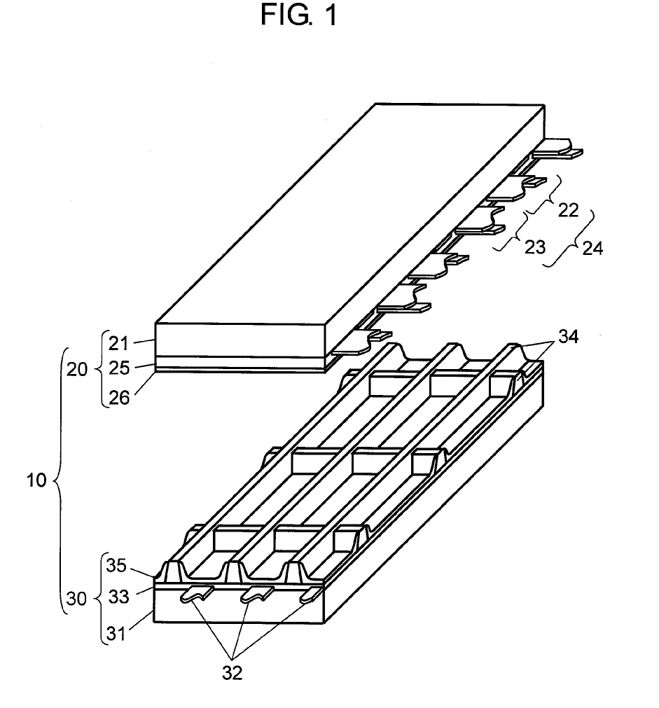

FIG. 1 is an exploded perspective view showing the structure of panel 10 in accordance with the exemplary embodiment of the present invention. On glass-made front substrate 21, a plurality of display electrodes 24, formed as a pair of scan electrodes 22 and sustain electrodes 23, are arranged, and over which, dielectric layer 25 and protective layer 26 are formed to cover display electrodes 24. On rear substrate 31, a plurality of data electrodes 32 are disposed, and over which, dielectric layer 33 is formed to cover data electrodes 32. On dielectric layer 33, barrier ribs 34 are formed in a grid arrangement. Phosphor layer 35, which is responsible for emitting light in red, green and blue, is formed on dielectric layer 33 and on the side surfaces of barrier ribs 34.

Front substrate 21 and rear substrate 31 are oppositely disposed in a manner that display electrodes 24 are placed orthogonal to data electrodes 32 in a narrow discharge space between the two substrates. The two substrates are sealed at the peripheries with a sealing material such as glass frit. The discharge space is filled with discharge gas, for example, a gas containing xenon with a partial pressure of 10%. The discharge space is divided into a plurality of sections by barrier ribs 34. Discharge cells are formed at intersections of display electrodes 24 and data electrodes 32. Generating discharge allows a discharge cell to emit light, so that an image appears on the panel.

Panel 10 does not necessarily have the structure above; the barrier ribs may be formed into stripes.

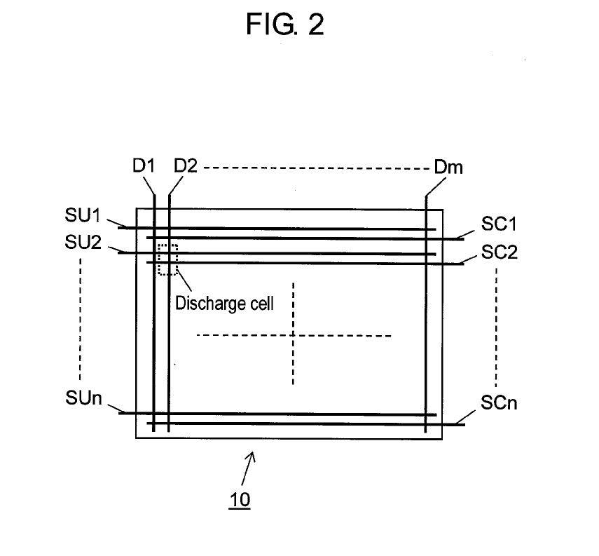

FIG. 2 shows arrangement of the electrodes on panel 10 in accordance with the embodiment. In the horizontal direction, panel 10 has n long scan electrodes SC1-SCn (corresponding to scan electrodes 22 in FIG. 1) and n long sustain electrodes SU1-SUn (corresponding to sustain electrodes 23 in FIG. 1). In the vertical direction, panel 10 has m long data electrodes D1-Dm (corresponding to data electrodes 32 in FIG. 1). A discharge cell is formed at an intersection of a pair of scan electrode SCi and sustain electrode SUi (where, i takes 1 to n) and data electrode Dj (where, j takes 1 to m). That is, panel 10 contains m×n discharge cells in the discharge space.

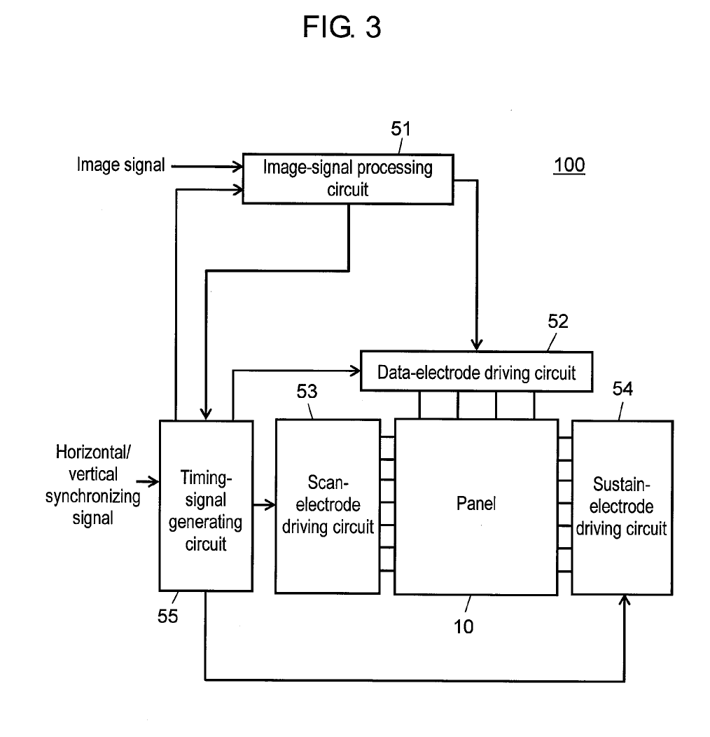

FIG. 3 is a circuit block diagram of plasma display device 100 having panel 10 of the embodiment. Plasma display device 100 has panel 10, image-signal processing circuit 51, data-electrode driving circuit 52, scan-electrode driving circuit 53, sustain-electrode driving circuit 54, timing-signal generating circuit 55, and a power supply circuit (not shown) for delivering power to each circuit block.

Receiving an image signal, image-signal processing circuit 51 converts it into image data for light-emitting or non-light-emitting on a subfield basis. Data-electrode driving circuit 52 converts the image data of each subfield into a signal for data electrodes D1-Dm to drive them.

Timing-signal generating circuit 55 generates timing signals that control each circuit block according to a horizontal synchronizing signal and a vertical synchronizing signal, and the timing signals are fed to each circuit block. According to the timing signals, scan-electrode driving circuit 53 and sustain-electrode driving circuit 54 drive scan electrodes 22 and sustain electrodes 23, respectively.

Next will be described waveforms of driving voltage for driving panel 10 and the workings of them. Plasma display device 100 employs a subfield method to provide gradation display. In the subfield method, one field is divided into a plurality of subfields. Light-emitting control of the discharge cells is carried out on a subfield basis. Each subfield has an initializing period, an address period and a sustain period.

The initializing period is responsible for generating an initializing discharge to form wall charges on each electrode as a preparation for an address discharge to be generated in the address period. In the initializing period, two types of initializing operations are selectively carried out: an all-cell initializing operation in which the initializing discharge occurs in all of the cells; and a selective-cell initializing operation in which the initializing discharge occurs in a cell where a sustain discharge occurred in the previous sustain period.

In the address period, application of voltage selectively causes an address discharge in a discharge cell to be lit and forms wall charges. In the sustain period, sustain pulses are alternately applied to display electrodes 24 so that a sustain discharge occurs in the discharge cell where an address discharge occurred. The number of the sustain pulses applied to the display electrodes corresponds to a luminance weight for light emitting. In this way, the discharge cells where the sustain discharge occurred emit light.

Descriptions in the embodiment will be given on the assumption that one field is divided into ten subfields from the first subfield (1SF) to the tenth subfield (10SF) and 1SF through 10SF have the following luminance weights in the order named: 1, 2, 3, 6, 11, 18, 30, 44, 60 and 80. In the embodiment, 1SF is the all-cell initializing subfield, while 2SF through 10SF are the selective-cell initializing subfields.

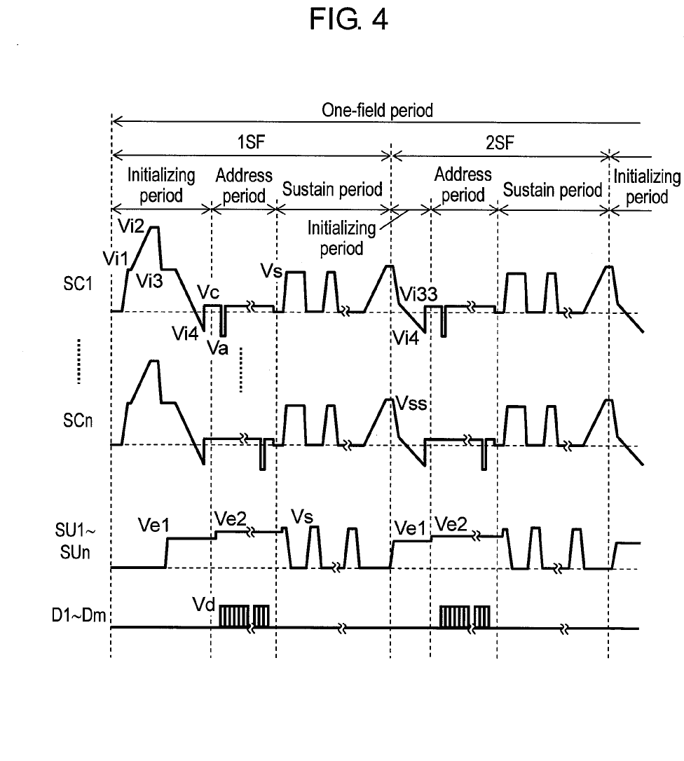

FIG. 4 illustrates a driving voltage waveform applied to each electrode of panel 10, showing 1SF where the all-cell initializing operation is carried out and 2SF where the selective-sell initializing operation is carried out.

In the first half of the initializing period of 1SF, data electrodes D1-Dm and sustain electrodes SU1-SUn undergo application of voltage of zero (0V), while scan electrodes SC1-SCn undergo application of voltage with gradually increasing waveform, starting from voltage Vi1 that is lower than the discharge-start voltage for sustain electrodes SU1-Sun, toward voltage Vi2 that exceeds the discharge-start voltage. During the application of voltage with gradual increase, a weak initializing discharge occurs between scan electrodes SC1-SCn, sustain electrodes SU1-SUn and data electrodes D1-Dm. Through the initializing discharge, negative wall voltage is built up on scan electrodes SC1-SCn; on the other hand, positive wall voltage is built up on data electrodes D1-Dm and sustain electrodes SU1-SUn. The wall voltage on each electrode represents a voltage generated by wall charges built up on the dielectric layer, the protective layer and the phosphor layer on the electrodes.

In the latter half of the initializing period, sustain electrodes SU1-SUn undergo application of positive voltage Ve1, while scan electrodes SC1-SCn undergo application of voltage with gradually decreasing waveform, starting from voltage Vi3 that is lower than the discharge-start voltage for sustain electrodes SU1-Sun, toward voltage Vi4 that exceeds the discharge-start voltage. During the application of voltage with gradual decrease, a weak initializing discharge occurs between scan electrodes SC1-SCn, sustain electrodes SU1-SUn and data electrodes D1-Dm. Through the discharge, the negative wall voltage on scan electrodes SC1-SCn and the positive wall voltage on sustain electrodes SU1-SUn are weakened. On the other hand, the positive wall voltage on data electrodes D1-Dm is adjusted to a value suitable for the addressing operation. In this way, the initializing discharge given on all the discharge cells, i.e., the all-cell initializing operation is completed.

In the address period that follows the initializing period, sustain electrodes SU1-SUn undergo application of voltage Ve2 and scan electrodes SC1-SCn undergo application of voltage Vc.

Next, negative scan pulse voltage Va is applied to scan electrode SC1 located at the first row, and positive address pulse voltage Vd is applied to data electrode Dk (k takes 1 to m), which corresponds to the discharge cell to be lit at the first row. At this time, difference in voltage at the intersection of data electrode Dk and scan electrode SC1 is calculated by adding the difference in wall voltage between data electrode Dk and scan electrode SC1 to the difference in voltage applied from outside (i.e., Vd−Va). The calculated value exceeds the discharge-start voltage, thereby generating an address discharge between data electrode Dk and scan electrode SC1, and between sustain electrode SU1 and scan electrode SC1. Through the address discharge, positive wall voltage is built up on scan electrode SC1 and negative wall voltage is built up on sustain electrode SU1 and data electrode Dk.

In an addressing operation, as described above, an address discharge is generated so as to build up wall voltage on each electrode in the discharge cell to be lit at the first row. On the other hand, the voltage at the intersection of scan electrode SC1 and the data electrodes with no application of address pulse voltage Vd is lower than the discharge-start voltage and therefore no address discharge. After the addressing operation is repeatedly carried out until the discharge cells located in the n^{th} row, the address period is completed.

In the sustain period that follows the address period, positive sustain pulse voltage Vs is applied to scan electrodes SC1-SCn, and at the same time, voltage of zero (0V) is applied to sustain electrodes SU1-SUn. In the discharge cell where an address discharge occurred in the previous period, difference between the voltage on scan electrode SCi and the voltage on sustain electrode SUi is calculated by adding sustain pulse voltage Vs to the difference between the wall voltage on scan electrode SCi and the wall voltage on sustain electrode SUi. The calculated value exceeds the discharge-start voltage, thereby generating a sustain discharge between scan electrode SCi and sustain electrode SUi. The sustain discharge produces ultraviolet light, allowing phosphor layer 35 to emit light. Negative wall voltage is built up on scan electrode SCi and positive wall voltage is built up on sustain electrode SUi and data electrode Dk. A discharge cell without an address discharge in the previous address period has no sustain discharge and therefore maintains the wall voltage the same as that at the end of the initializing period.

Next, voltage of zero (0V) is applied to scan electrodes SC1-SCn and sustain pulse voltage Vs is applied to sustain electrodes SU1-SUn. In the discharge cell where a sustain discharge occurred, difference between the voltage on sustain electrode SUi and the voltage on scan electrode SCi exceeds the discharge-start voltage, thereby generating a sustain discharge again between sustain electrode SUi and scan electrode SCi. Through the discharge, negative wall voltage is built up on sustain electrode SUi and positive wall voltage is built up on scan electrode SCi. In this way, scan electrodes SC1-SCn and sustain electrodes SU1-SUn alternately undergo sustain pulses where the number of the pulses to be applied are determined by multiplying a luminance weight by a luminance factor, providing difference in potential between a scan electrode and a sustain electrode. This allows the sustain discharge to repeatedly occur in a discharge cell where an address discharge occurred in the address period.

At the end of the sustain period, a mildly increasing voltage with a ramp waveform is applied to scan electrodes SC1-SCn. The application of voltage erases wall voltage on scan electrode SCi and sustain electrode SUi, with the positive wall voltage on data electrode Dk maintained. That is, after the voltage of sustain electrodes SU1-SUn is set to 0V, scan electrodes SC1-SCn undergo application of voltage with a ramp waveform that exhibits a mild increase to a level as high as sustain pulse voltage Vs or voltage Vss that is higher than voltage Vs. The application of voltage causes a weak discharge between sustain electrode SUi and scan electrode SCi in the cell where a sustain discharge occurred, which weakens the wall voltage between sustain electrode SUi and scan electrode SCi. The sustain operation in the sustain period thus complete.

In the selective-cell initializing operation of the initializing period in 2SF, sustain electrodes SU1-SUn undergo application of voltage Ve1 and data electrodes D1-Dm undergo application of voltage of zero (0V). Scan electrodes SC1-SCn undergo application of voltage with a ramp waveform gradually decreasing from voltage Vi33 toward voltage Vi4. During the application of voltage above, a weak initializing discharge occurs in a discharge cell where a sustain discharge occurred in the sustain period in the previous subfield. The discharge weakens wall voltage on scan electrode SCi and sustain electrode SUi. A sufficient amount of positive wall voltage is built up on electrode Dk. An excessive amount of the wall voltage is discharged, so that a proper amount of wall voltage is left for the addressing operation.

A discharge cell without a sustain discharge in the previous subfield has no initializing discharge and therefore maintains the wall voltage the same as that at the end of the initializing period of the previous subfield. As described above, the selective-cell initializing operation is carried out selectively on a discharge cell where the sustain operation occurred in the sustain period of the previous subfield.

The operations of address period of the selective-cell initializing subfield are similar to those of the all-cell initializing subfield and descriptions thereof will be omitted. The operations of the sustain period that follows the address period are also similar to those of the all-cell initializing subfield except for the number of sustain pulses. The operations in 3SF through 10SF are carried out similar to that of 2SF.

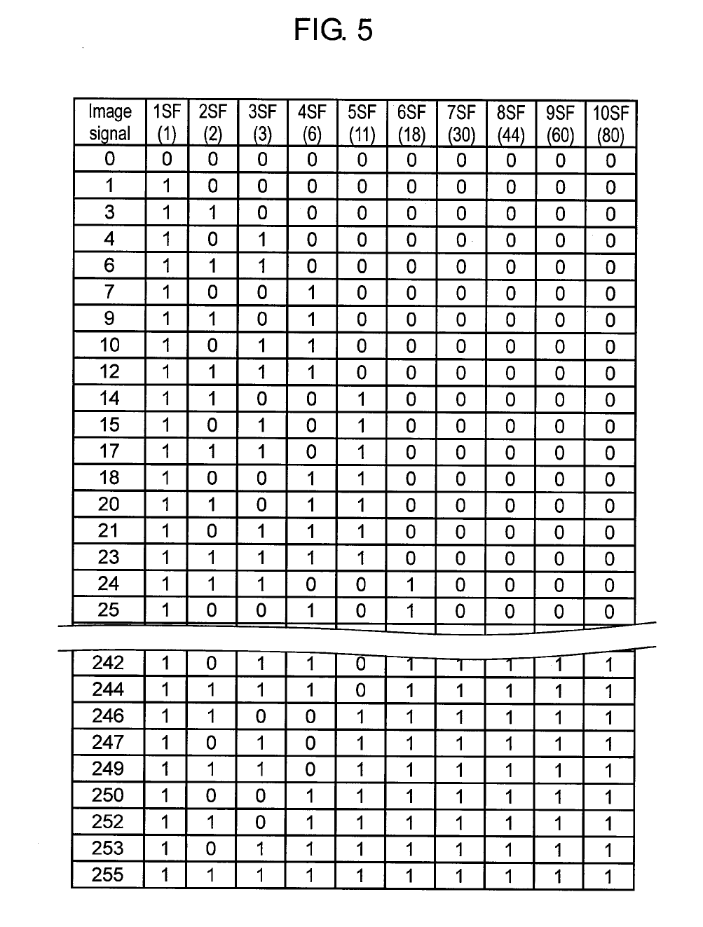

Next will be described how to show gradation in the exemplary embodiment. FIG. 5 shows combination of the subfields with and without an addressing operation (hereinafter, coding) to achieve each gradation level in accordance with the embodiment. In the table, ‘1’ represents the presence of the addressing operation and ‘0’ represents the absence of the addressing operation. For example, in the discharge cell responsible for showing a gradation level of ‘0’ that corresponds to black color, all the subfields of 1SF to 10SF have no addressing operation. The absence of the addressing operation generates no sustain discharge through one field, providing the lowest level of luminance.

In the discharge cell responsible for a gradation level of ‘1’, the addressing operation is carried out in only the cell having a luminance weight of ‘1’, by which luminance corresponding to a gradation level of ‘1’ is obtained.

In the discharge cell responsible for a gradation level of 3, the addressing operation is carried out in the address period of 1SF with a luminance weight of ‘1’ and in the address period of 2SF with a luminance weight of ‘2’. That is, in the discharge cell above, the number of sustain discharges that occur in 1SF and 2SF corresponds to a luminance weight of ‘1’ and ‘2’, respectively; in total, a gradation level of ‘3’ is obtained.

Similarly, in the discharge cell responsible for a gradation level of ‘4’, the addressing operation is carried out in each address period of 1SF and 3SF; for a gradation level of ‘6’, the addressing operation is carried out in 1SF, 2SF and 3SF; for a gradation level of ‘7’, the addressing operation is carried out in 1SF and 4SF. As for other gradation levels, as is shown in the coding of FIG. 5, a desirable one is obtained by the coding shown in FIG. 5.

According to the embodiment, in the subfields other than 1SF (i.e., the subfields having selective-cell initializing operation in the rest period), the gradation level is determined by “random” coding—a combination of subfields having the addressing operation and subfields having no addressing operation.

With the use of the random coding, a panel shows images with a number of gradation levels. In the random coding of the embodiment, a discharge cell that has an addressing operation in any one of 2SF through 10SF also has an addressing operation in 1SF. In other words, a discharge cell having no addressing operation in 1SF has no addressing operation in the rest of the subfields. The gradation display by the aforementioned coding allows a panel, even in a high-resolution panel, to have excellent image display with no malfunction.

Here will be described the advantage of the coding above. In general, a discharge generates positively/negatively charged particles in a discharge space. When the charged particles attach to the wall of a discharge cell, wall voltage varies and accordingly, field intensity in the discharge space varies. The change in wall voltage and field intensity affects discharging. Suppose that discharge cell B has an address discharge next to discharge cell A that has no addressing operation. When charged particles generated in discharge cell B fly into discharge cell A, the wall voltage in discharge cell A can decrease. If the positive wall voltage on an electrode has an excessive decrease, subsequent addressing operations cannot be expected. The malfunction can degrade the quality of image display.

The following were known by the experiment by the inventor. The application of high voltage to all the discharge cells causes a malfunction in which an addressing operation cannot be expected in the address period after an all-cell initializing operation having an initializing discharge, degrading the quality of image display. The unwanted phenomenon occurs at very low frequency in an address period that follows a selective-cell initializing operation in which a mildly decreasing voltage with a ramp waveform is applied to the scan electrodes after the application of a mildly increasing voltage with a ramp waveform to the scan electrodes in the end of a sustain period. Besides, the phenomenon easily occurs in a panel with higher resolution. In a panel with high resolution, discharge cells are small in size and wall charges that determine wall voltage are small in amount; even a small decrease in wall charges causes a large decrease in wall voltage.

According to the coding of the embodiment, however, a discharge cell having no addressing operation in 1SF has no addressing operation in 2SF through 10SF. That is, even if wall voltage decreases in a discharge cell having no addressing operation in the address period of 1SF, it has no ill effect on the quality of image display, since the address periods of 2SF through 10SF have no addressing operation.

Although some gradation levels, such as a gradation level of ‘2’ and ‘5’, are not shown in the coding of FIG. 5, they can be obtained by changing a luminance weight of each subfield or adding another subfield having a luminance weight of ‘1’.

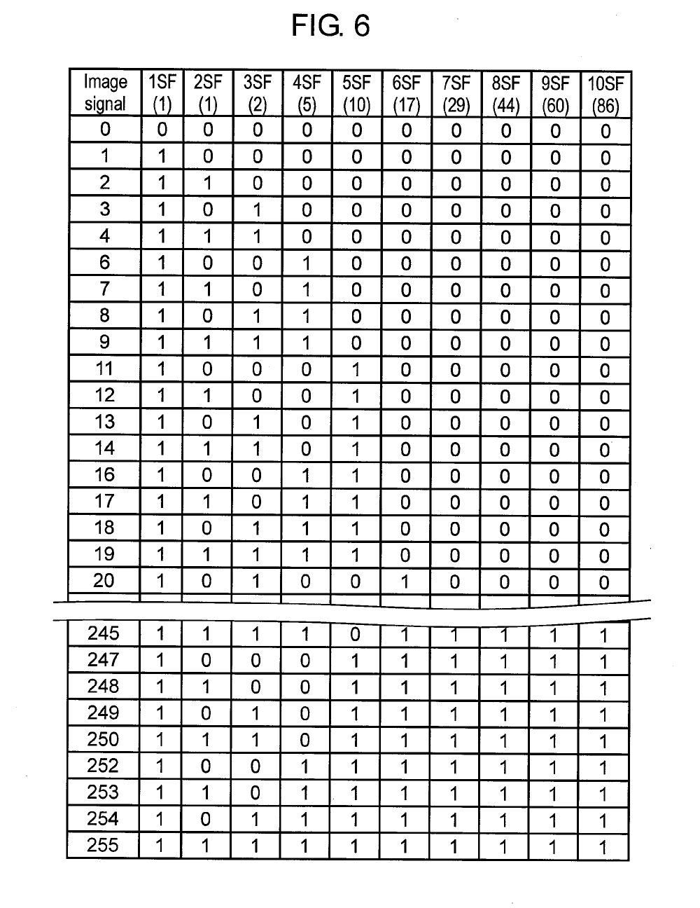

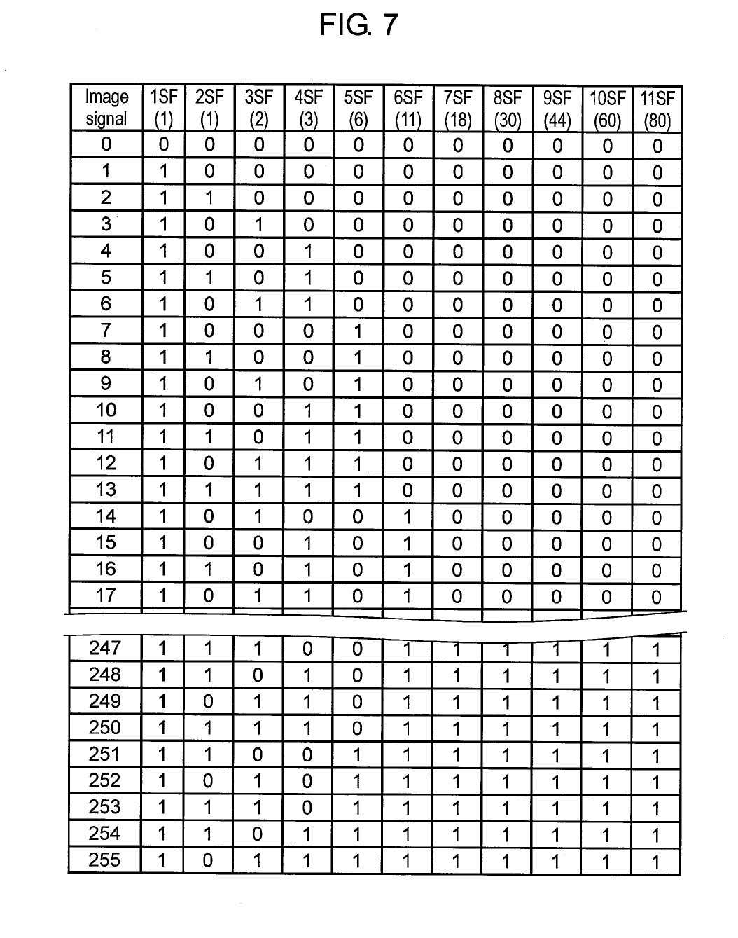

FIG. 6 shows another coding example where each subfield has a luminance weight different from that of FIG. 5. FIG. 7 shows still another coding example where one-filed period contains another subfield having a luminance weight of ‘1’.

The number of subfields and luminance weight assigned to each subfield are not limited to the coding examples above; they should be determined to an optimum value according to image to be shown.

Besides, numeric values are cited merely by way of example and without limitation; they should be properly determined according to characteristics of a panel and specifications of a plasma display device.

### INDUSTRIAL APPLICABILITY

The present invention is suitable for providing a method for driving plasma display panel and a plasma display device without malfunction even in a high-resolution panel, offering display image of excellent quality.

1. A method for driving a plasma display panel having a plurality of discharge cells, each of the discharge cells including a display electrode pair, which is formed of a scan electrode and a sustain electrode, and a data electrode,
wherein one field is formed by a plurality of subfields, each of the subfields having:
an initializing period for generating an initializing discharge in the discharge cell;
an address period for selectively generating an address discharge in the discharge cell; and
a sustain period for generating a sustain discharge in the discharge cell where an address discharge has been generated in the address period,
wherein the one field includes an all-cell initializing subfield performing an all-cell initializing operation in which the initializing discharge is generated in all the discharge cells and a selective-cell initializing subfield performing a selective-cell initializing operation in which the initializing discharge is generated only in a discharge cell generating a sustain discharge in a previous subfield,
the method comprising:
applying a mildly increasing voltage with a ramp waveform to the scan electrodes at an end of the sustain period;
performing gradation control by arbitrarily combining
a subfield having the address period for generating the address discharge; and
a subfield having the address period for not generating the address discharge, in the selective-cell initializing subfield
providing the address period for generating the address discharge even in the address period of the subfield for performing the all-cell initializing operation
in the discharge cell where the address discharge is generated in the address period having the initializing period of any selective-cell initializing subfield that follows the subfield having the initializing period for performing the all-cell initializing operation.

2. (canceled)

3. A plasma display device comprising:
a plasma display panel having a plurality of discharge cells, each of the discharge cells including a display electrode pair, which is formed of a scan electrode and a sustain electrode, and a data electrode; and
a driving circuit for driving the plasma display panel,
wherein one field is formed by a plurality of subfields, each of the subfields having:
an initializing period for generating an initializing discharge in the discharge cell;
an address period for selectively generating an address discharge in the discharge cell; and
a sustain period for generating a sustain discharge in the discharge cell where an address discharge has been generated in the address period,
wherein the driving circuit performs an all-cell initializing operation for generating the initializing discharge in all the discharge cells, where images are to be displayed, in the initializing period of at least one of the subfields,
wherein a mildly increasing voltage with a ramp waveform is applied to the scan electrodes at an end of the sustain period,
wherein generation of the address discharge is controlled even in the address period of any subfield having the initializing period for performing the all-cell initializing operation in the discharge cell where the address discharge is generated in the address period of a subfield that follows the subfield having the initializing period for performing the all-cell initializing operation.
